(19) United States
(12) Patent Application Publication
(10) Pub. No.: US 2018/0373355 A1
(43) Pub. Date: Dec. 27, 2018

(54) TOUCHPAD AND METHOD FOR MANUFACTURING SAME

(71) Applicant: LENOVO (SINGAPORE) PTE. LTD., Singapore (SG)

(72) Inventors: Kazutoshi Sugisawa, Yokohama-shi (JP); Masahiro Kitamura, Yokohama-shi (JP)

(73) Assignee: LENOVO (SINGAPORE) PTE. LTD., Singapore (SG)

(21) Appl. No.: 15/692,763

(22) Filed: Aug. 31, 2017

(30) Foreign Application Priority Data
Jun. 26, 2017 (JP) 2017124157

(51) Int. Cl. G06F 3/0354; G06F 1/16; G06F 3/01; G06F 3/041

(52) U.S. Cl. CPC G06F 3/03547; G06F 1/169; G06F 1/1616; G06F 3/041; G06F 3/011

(57) ABSTRACT

A touchpad has a pad plate which is less expensive and has better surface feeling and oil resistance than a glass pad plate and a method for manufacturing the same. The touchpad has a resin base portion having electrical insulation properties, a photocurable resin layer laminated so as to cover the top of the base portion, and an anti-finger film laminated so as to cover the top of the photocurable resin layer, in which the anti-finger film is a touch operation surface.

### FIELD OF THE INVENTION

The present invention relates to a touchpad and a method for manufacturing the same.

### BACKGROUND OF THE INVENTION

Electronic devices, such as a notebook personal computer (Laptop PC) and a tablet personal computer (tablet PC), have input devices for operating a cursor (mouse pointer) displayed on a display (Patent Document 1).

As one of the input devices, a touchpad is mentioned. The touchpad is an input unit which enables an operation of a mouse pointer by tracing a plate-like sensor with a finger or the like and which can be operated as a substitute for a mouse.

The touchpad usually has a substrate plate detecting a touch operation and a pad plate having a touch operation surface laminated in an upper portion of the substrate plate.

The pad plate is generally a glass plate or a resin plate. Raw materials of the resin plate are polycarbonate (PC), polyethylene terephthalate (PET), polyurethane (PU), and the like.

[Patent Document 1] Japanese Patent Application Laid-Open No. 2017-27684 (Paragraph 0025 and Paragraph 0028)

### SUMMARY OF THE INVENTION

The glass pad plate has a good feeling but is expensive. In order to achieve a lower-cost touchpad, a resin pad plate is preferably used.

However, the resin pad plate has problems that the feeling is bad and the oil resistance is not so high as compared with the feeling and the oil resistance of the glass pad plate.

The present invention has been made in view of such circumstances. It is an object of the present invention to provide a touchpad having a pad plate having good surface feeling and oil resistance at a cost lower than the cost of a touchpad having a glass pad plate.

In order to solve the above-described problems, a touchpad and a method for manufacturing the same according to an aspect of the present invention adopts the following units.

An aspect of the present invention provides a touchpad having a resin base portion having electrical insulation properties, a photocurable resin layer laminated so as to cover the top of the base portion, and an anti-finger film laminated so as to cover the top of the photocurable resin layer, in which the anti-finger film is a touch operation surface.

Moreover, the present invention provides a method for manufacturing a touchpad including applying a photocurable resin composition onto a resin base portion having electrical insulation properties, emitting light to cure the photocurable resin composition to form a photocurable resin layer, and then spraying or vapor-depositing oxide or fluoride onto the photocurable resin layer to form an anti-finger film.

By using a resin member for the base portion, a lower-cost touchpad than one having a glass base portion is provided. By laminating the anti-finger film on the base portion to form a touch operation surface, the oil resistance of the touch operation surface can be improved and friction can be reduced to achieve ease of sliding. Thus, a fingerprint, fat, and dirt are less likely to adhere to the touch operation surface and the feeling also improves.

On the other hand, when the anti-finger film is merely laminated on the base portion, the strength is lower than one made of glass. In order to compensate the strength, a photocurable resin layer is disposed between the base portion and the anti-finger film in one aspect of the present invention. The photocurable resin layer is obtained by curing a resin by light, and therefore can be formed into a layer harder than the base portion. By providing the photocurable resin layer on the base portion, the durability to friction and the like and chemical resistance improve. Moreover, disposing the photocurable resin layer therebetween can make it difficult to cause the separation of the anti-finger film, and therefore the life of the touchpad can be extended.

According to an aspect of the present invention, the touchpad in which the photocurable resin layer and the anti-finger film are successively laminated on the resin base portion is less expensive and has better surface feeling and higher oil resistance than one having a glass base portion.

### BRIEF DESCRIPTION OF THE DRAWINGS

FIG. 1 is a perspective view of a Laptop PC having a touchpad according to one embodiment.

FIG. 2 is a partial vertical cross sectional view of the touchpad.

FIG. 3 is a view illustrating RCA test results.

### DETAILED DESCRIPTION OF THE INVENTION

Hereinafter, a touchpad according to an aspect of the present invention is described in detail based on a preferable embodiment in the relationship with an electronic device having the touchpad with reference to the attached drawings.

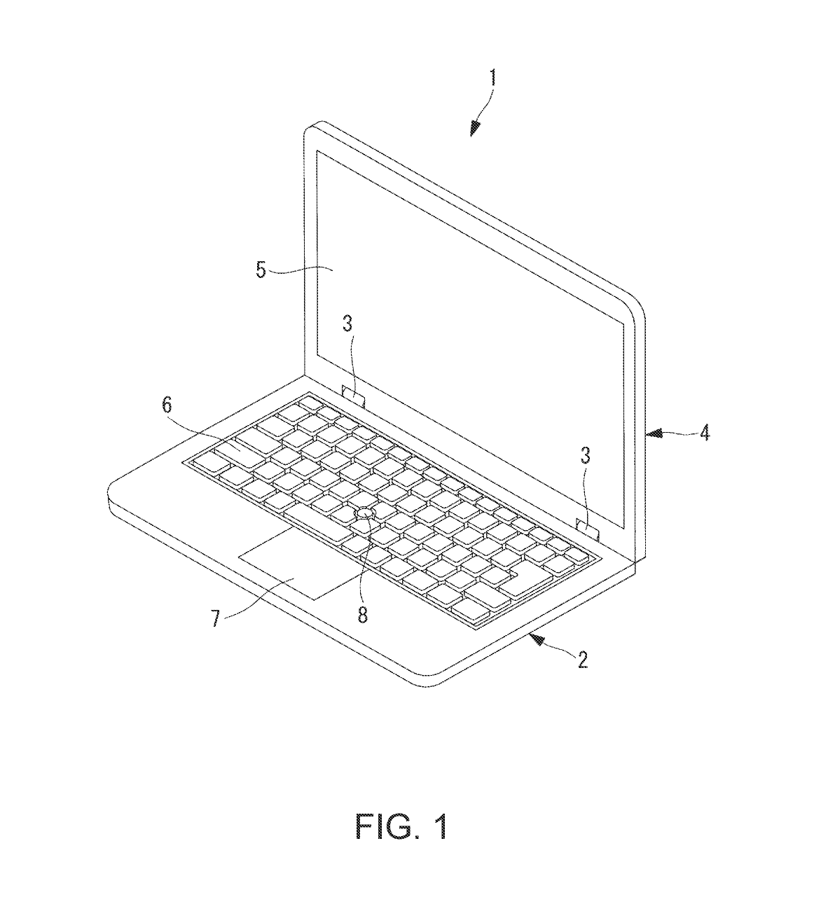

FIG. 1 is a perspective view of a Laptop PC (electronic device) having a touchpad according to this embodiment.

A Laptop PC 1 has a body chassis 2 and a display chassis 4 openably and closably connected to the body chassis 2 through hinges 3. In this embodiment, the body chassis 2 and the display chassis 4 are substantially rectangular parallelepipeds. The Laptop PC 1 can be brought into a closed state by tilting the display chassis 4 to the body chassis 2 side.

The body chassis 2 accommodates various kinds of electronic components, such as a substrate, an arithmetic processing device, a hard disk device, and a memory which are not illustrated, thereinside.

The display chassis 4 is provided with a display device 5, such as a liquid crystal display, for displaying and outputting various kinds of information.

The body chassis 2 has a keyboard device 6 and a touchpad 7 for inputting various kinds of information. At substantially the center of the keyboard device 6, a pointing stick 8 is provided. The touchpad 7 and the pointing stick 8 each are used for operating a cursor (mouse pointer) and are input units to be operated as a substitute for a mouse.

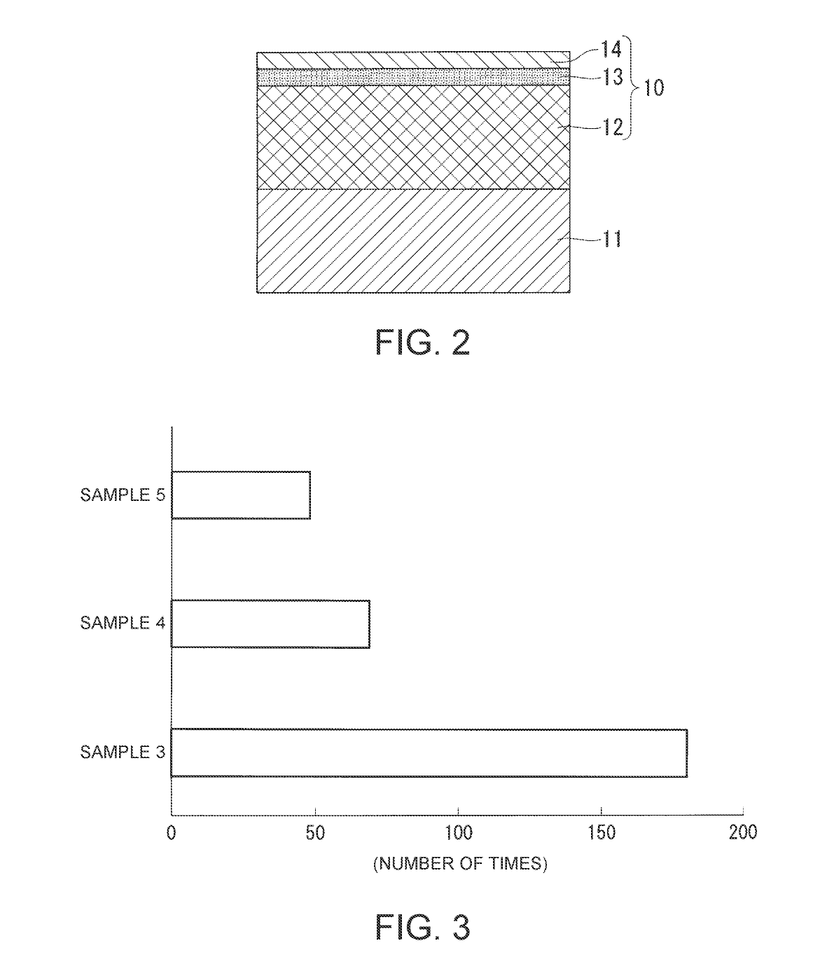

FIG. 2 is a partial vertical cross sectional view of a touchpad 7. The touchpad 7 receives a touch operation by approach or contact of a fingertip or the like. The touchpad 7 of this embodiment is configured as a click pad capable of performing a click operation by a depression operation in addition to the touch operation.

The touchpad 7 has a pad plate 10 serving as a touch operation surface receiving the touch operation and a substrate plate 11 detecting the touch operation to the touch operation surface.

The substrate plate 11 is an electronic substrate having a rectangular shape as viewed in plane and is connected to the substrate in the body chassis 2 by wiring which is not illustrated. The substrate plate 11 is a sensor detecting the touch operation to the pad plate 10 and the depression operation to the touchpad 7.

The pad plate 10 is fixed to the upper surface of the substrate plate 11 with an adhesive, a double-stick tape, or the like.

The pad plate 10 has a base portion 12, a photocurable resin layer 13, and an anti-finger film (AF film) 14. The base portion 12 is fixed to the substrate plate 11. The AF film is disposed on the outermost surface of the pad plate 10 to serve as a touch operation surface. The photocurable resin layer 13 is disposed so as to be held between the base portion 12 and the AF film 14. The photocurable resin layer 13 covers the entire surface on the AF film 14 side of the base portion 12. The AF film 14 covers the entire surface of the photocurable resin layer 13.

The base portion 12 is made of resin. The resin is a polyethylene terephthalate (PET) resin, a polycarbonate (PC) resin, or an acrylic resin (for example, polymethylmethacrylate). The resin is an electrical insulating material. As the resin, one having heat resistance to about −40° C. to about 120° C. is selected. The thickness of the base portion 12 may be generally set to 0.15 mm or more and 0.6 mm or less.

The photocurable resin layer 13 is harder than the base portion 12 and can protect the base portion 12 from a load to be applied from the outside. The thickness of the photocurable resin layer 13 may be set to 0.02 mm or more and 0.04 mm or less.

The photocurable resin layer 13 is a layer obtained by curing a photocurable resin composition. The photocurable resin composition contains a monomer or an oligomer of a resin (photocurable resin) which causes a polymerization reaction by light irradiation to be cured as the main component. The main component means the highest content component. The photocurable resin composition before curing is a liquid.

The photocurable resin may be either a radical polymerization type or a cationic polymerization type. For example, the photocurable resin is an acrylate resin or an epoxy resin. The photocurable resin may be a commercially-available ultraviolet curable resin. When a polymethacrylic acid ester resin is used for the photocurable resin, an acrylic acid resin or an acrylic acid ester resin may be used for the material of the base portion 12.

The photocurable resin composition contains a photopolymerization initiator. The photopolymerization initiator is a compound which generates an acid radical which finally becomes acid when irradiated with light or a compound which generates other radicals when irradiated with light (Hereinafter, the acid radical and the other radicals are referred to as “radical” without discrimination.). The photopolymerization initiator is α-hydroxyacetophenone, for example. For the photopolymerization initiator, other known substances may be used.

The photocurable resin composition may also contain a solvent, a pigment, and other additives. As the solvent, one which has volatility and does not remain in the photocurable resin layer 13 after curing the photocurable resin composition is used.

The AF film 14 is a film giving water resistance and oil resistance to the pad plate 10. The AF film 14 can prevent the adhesion of a fingerprint. The thickness of the AF film 14 may be set to 0.03 mm or more and 0.06 mm or less.

The AF film 14 is a film containing fluoride as the main component. The fluoride is a polytetrafluoroethylene type (PTFE), a polytetrafluoroethylene type (PFA), a tetrafluoroethylene type (FEP), or the like. The AF film 14 may be an ethylene tetrafluoroethylene copolymer resin (ETFE) or a modified paint containing fluororesin and an organic binder resin.

Next, a method for manufacturing the pad plate 10 is described.

First, a material (photocurable resin composition) of the photocurable resin layer 13 is applied onto the base portion 12 to form a coating film. The application can be performed by a spray or roller coater coating.

Next, a coating film is irradiated with light. The wavelength of the irradiation light is selected from a range where the used photocurable resin composition may be cured. For example, when curing a commercially-available ultraviolet curable resin, ultraviolet rays with a wavelength of 450 nm to 280 nm are emitted.

When irradiated with light, a photopolymerization initiator absorbs the energy of the light to be changed to a radical. The photocurable resin composition causes a polymerization reaction by the radical to be cured. Thus, the coating film is formed into a solid (photocurable resin layer 13).

Next, the AF film 14 is formed on the photocurable resin layer 13 formed on the base portion 12. For the formation of the AF film 14, known spray methods, physical vapor deposition methods (PVD), chemical vapor deposition methods (CVD), and the like may be adopted.

Herein, a method for forming the AF film 14 by PVD is exemplarily described. The base portion 12 having the photocurable resin layer 13 is set in a chamber of a physical vapor deposition device, and then the inside of the chamber is evacuated. The inside of the chamber may be set to about 10⁻⁴ Pa from about 10⁻³ Pa. Thus, the evaporation temperature of an AF film material (oxide or fluoride) can be lowered, which facilitates vapor deposition. Moreover, excess gas molecules in the chamber can be discharged by the evacuation. Therefore, the collision of the evaporated AF film material with remaining gas molecules can be avoided.

The AF film material is heated under the vacuum environment in the chamber to be vapor-deposited onto the surface of the photocurable resin layer 13 to form the AF film 14.

<Verification of Water Resistance and Oil Resistance>

Using the following samples 1 and 2, each sample surface was rubbed 3000 times with ram wool (wool felt). Before and after the rubbing, the water drop angle of the surface of the samples 1 and 2 was measured. The “water drop angle” is an angle θ formed by the tangent of a water drop and the sample surface.

Sample 1: Base portion/Photocurable resin layer (0.03 mm)

Sample 2: Base portion/Photocurable resin layer (0.03 mm)/AF film (0.04 mm)

For the base portion, a PET (manufactured by Inhontech, IHAG77) was used. A photocurable resin layer was formed on the base portion to be used as the sample 1. Moreover, one obtained by forming a photocurable resin layer in the same manner as in the sample 1, and then forming an AF film on the photocurable resin layer by a PVD method was used as the sample 2.

The measurement results of the water drop angle are shown in Table 1.

TABLE 1

| | Sample 1 | Sample 2 |
|---|---|---|
| Water drop angle (°) | 89.1 to 77.1 | 131 to 124 |

The water drop angle of the surface of the sample 1 before the rubbing (0 rubbing) was 89.1° but was 77.1° after the rubbing (3000 times of rubbing). The water drop angle of the surface of the sample 2 before the rubbing (0 rubbing) was 131° but was 124° after the rubbing (3000 times of rubbing). The water drop angle on the sample surface before and after the rubbing of the sample 2 having the AF film on the surface was larger than that of the sample 1. It was able to verify by the above-described result that the water resistance and the oil resistance can be improved by providing the AF film.

<RCA Test>

An RCA test was carried out using the following samples 3 to 5. The RCA test tests the wear resistance by applying a load to the surface of a coil-like sample at a fixed speed.

Sample 3: Base portion/Photocurable resin layer (0.03 mm)/AF film (0.04 mm)

Sample 4: Base portion/Photocurable resin layer (0.03 mm)

Sample 5: Base portion/AF film (0.04 mm)

As the test conditions, the load was set to 175 g and the sample movement speed was set to about 60 mm/s, and then the number of times of rubbing until the base portion surface (Photocurable resin layer 13 in the sample 3, Base portion 12 in the samples 4 and 5) was exposed was counted.

FIG. 3 illustrates the test results. In the figure, the horizontal axis represents the number of times of rubbing to the sample. The base portion surface was exposed when rubbed 180 times in the sample 3, when rubbed 68 times in the sample 4, and when rubbed 47 times in the sample 5. It was verified by the results that, by laminating the photocurable resin layer/AF film on the base portion, the wear resistance improves by about 2 times than one in which only the photocurable resin layer was laminated.

It was also verified that the life of the AF film was extended in the case where the AF film was laminated on the base portion through the photocurable resin layer than the case where the AF film was directly laminated on the base portion.

After the test, the presence of scratches, air bubbles, cracks, and discoloration of the sample surface was visually checked. Cracks and the like were not observed on the sample 3 surface. This result shows that the surface of the sample 3 after the test had no composition changes or surface property changes. Thus, it was found that the configuration of Base portion/Photocurable resin layer/AF film of the sample 3 is suitable for the use by a user and has no adverse effects.

In the above-described embodiment, the Laptop PC is mentioned as an example of an electronic device but, without limitation thereto, a touchpad may be mounted in a single keyboard device or the like to be connected to a desktop PC or the like.

1. A touchpad, comprising:
a resin base portion having electrical insulation properties;
a photocurable resin layer laminated to directly contact and cover a top of the base portion; and
an anti-finger film laminated to directly contact and cover a top of the photocurable resin layer, wherein:
the anti-finger film is a touch operation surface configured to be directly touched by a user.

2. The touchpad according to claim 1, wherein:
the photocurable resin layer contains a cured photocurable resin composition, and
the anti-finger film contains oxide or fluoride.

3. A method for manufacturing a touchpad, comprising:
applying a photocurable resin composition directly onto a resin base portion having electrical insulation properties, and then emitting light to cure the photocurable resin composition to form a photocurable resin layer; and
spraying or vapor-depositing oxide or fluoride directly onto the photocurable resin layer to form an anti-finger film.
